(19) United States
(12) Patent Application Publication
(10) Pub. No.: US 2007/0104816 A1
(43) Pub. Date: May 10, 2007

(54) System and method for firing bricks

(75) Inventors: J. Russell Woodside, Crystal Lake, IL (US); Ryan F. Washburn, Crystal Lake, IL (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Eisenmann Corporation, Crystal Lake, IL (US)

(21) Appl. No.: 10/573,425

(22) PCT Filed: Sep. 27, 2004
(86) PCT No.: PCT/US04/31703

§ 371 Date: May 26, 2006

Related U.S. Application Data
(60) Provisional application No. 60/506,387, filed on Sep. 26, 2003.

(51) Int. Cl. A21C 11/10

(52) U.S. Cl. 425/289

(57) ABSTRACT

A method for firing bricks provides a kiln car including furniture with silicon carbide vertical supports. In one embodiment, horizontal support beams are mounted to the vertical supports to define multiple vertical levels and support crossbeams. Low sets of bricks are positioned on a first carriage having a conveyor, near one side of the kiln car. A second carriage is extended beneath crossbeams for one level to a position adjacent the first carriage. The second carriage includes spaced-apart rollers that inter-fit between crossbeams for the level when the carriages are raised, so that tops of the rollers are slightly above the crossbeams. The rollers convey bricks to a desired position, and the carriages are lowered to rest the bricks on the crossbeams. Another embodiment uses a fork to load and unload crossbeams carrying bricks from the horizontal support beams.

### CROSS-REFERENCE TO RELATED PATENT APPLICATIONS

This patent application claims the benefit of U.S. Provisional Patent Application No. 60/506,387, filed Sep. 26, 2003.

### FIELD OF THE INVENTION

The invention is directed to a system and method for loading unfired bricks onto a kiln car and unloading fired bricks from a kiln car having multiple levels for holding bricks and also for firing the bricks.

### BACKGROUND OF THE INVENTION

Bricks are classified under the North American Industry Classification System (NAICS) as “Brick and Structural Clay Tile”. Most of the bricks made in America are referred to as “face brick,” and are used in combination with wooden frame or concrete block for building facings. Additionally, paving bricks are used for sidewalks, streets and driveways.

Bricks are commonly formed by extruding a mixture of clay, water and other known ingredients, but may also be formed by pressing. After the bricks are formed, they must be heated or “fired” at high temperatures in a kiln in order to remove moisture and harden the bricks. The unfired bricks are referred to as “green bricks,” and have about 18% moisture. This moisture must be removed before the bricks can be useful. Face brick are commonly provided in standard 8 inch and 12 inch sizes. In particular, individual 8 inch green bricks typically have standard dimensions of about 2.4″×4.0″×8.6″ and weigh about 5 to 6 pounds, and individual 12 inch green bricks typically have standard dimensions of about 3.9″×3.9″×12.5″ and weigh about 13 to 14 pounds.

If bricks having an 18% moisture content are introduced into a kiln, the bricks would explode due to the rapid build-up of steam within the brick. To avoid having the bricks explode, the bricks must be first dried in a dryer before introducing them into the kiln.

The kilns, which are constructed of refractories, are typically maintained within a specific temperature range of 1800 to 2200° F. In manufacturing plants in the United States, kiln cars are typically used to transport green bricks through the kilns by way of a rail system. For example, nearly all bricks are fired in “tunnel kilns”, which employ a continuous firing process in order to maximize the efficiency of the brick firing operation. The bricks are placed on kiln cars that move through the kiln during the firing process, the bricks entering the kiln in the unfired state and exiting the kiln in a fired state. The amount of time the bricks must remain in the kiln depends on the size of the bricks and how they are stacked on the kiln cars. The continuous movement of loaded kiln cars through the kilns at such high temperatures requires the structure and composition of the kiln cars to be extremely durable.

Conventional kiln cars have a refractory base on the kiln car (i.e., a deck) upon which the bricks are stacked. The refractory base has a support system made from pyrophylite or cordierite. The most common currently used practice is to stack bricks on a solid deck 8 to 14 courses high and 3 bricks long with a space for firing between these packs. This results in a pack that is approximately 30 inches to 52 inches high by 26 inches deep. The width of the pack is typically 20 feet or more. The firing lane between packs is around 20 inches. Burners in the kiln fire in these lanes from either the top or the sides. For this type of firing, the car is pushed incrementally, aligning the firing lane with the burners after each “push” (called “index pushing”).

Bricks have also been stacked on a raised deck and the burners fire under and over the load. With this practice, when the bricks are stacked 8 to 14 courses high, the firing cycle is similar to index firing concept, typically 30-48 hours.

Kilns have also been built for firing stacks of bricks that are two bricks high. The firing cycle using such stacks, e.g. low set stacks, is shortened dramatically, depending on the characteristics of the raw material.

Kiln car furniture is known for firing ceramic items other than bricks, wherein the furniture defines multiple levels within the height of a kiln. Such a multiple-level configuration yields increased firing capacity of the items. However, conventional kiln-car furniture has not been sufficiently strong enough to support multiple-levels of bricks.

With rising fuel, capital, and labor costs, a need exists for a system of loading and unloading a kiln car wherein the maximum number of bricks can be efficiently fired and at the same time, not cause premature wear on the kiln car.

### SUMMARY OF THE INVENTION

The present invention overcomes disadvantages of the prior art and provides an improved method and system for loading bricks on a kiln car.

In an embodiment, the present invention provides a kiln car having furniture that defines multiple vertical levels for supporting low set-stacks of bricks. As used herein, the term “low set stack” refers to a stack of bricks that is about two bricks high (typically two bricks high, but possibly less or more), such that the stack has a relatively low vertical height. At least some of the furniture components may be constructed of silicon carbide, which has high strength properties, in order to support multiple levels of bricks. The ability to fire multiple levels of low set stacks of bricks is highly efficient, as the configuration provides spacing among relatively small packs of bricks, thereby improving circulation, convection, and moisture removal among small brick packs, which have respectively lower thermal capacitance than conventional large stacks.

Advantageously, firing times are reduced. Per-car capacity is also improved in comparison to conventional single-level firing of a low set stack, and per-car capacity is not significantly sacrificed over traditional high set stacks of bricks, which require much longer firing times. The kiln car can be automatically loaded and unloaded with bricks according to a method of the invention.

An embodiment of a method for loading bricks, according to the present invention, calls for providing a kiln car having furniture defining multiple support levels, the furniture including vertical posts made of silicon carbide, and wherein each of the support levels includes a plurality of horizontal support beams made of silicon carbide, each of the horizontal support beams being mounted to extend between a pair of the posts, and a plurality of generally parallel, horizontal cross-beams extending between the support beams, the kiln car having opposite proximal and distal ends. The embodiment also calls for positioning the kiln car between a first machine and a second machine, the first machine including a first carriage with a conveyor, the second machine including a second carriage with rollers, the proximal end facing the first carriage, and the distal end facing the second carriage, the second carriage having a plurality of spaced-apart rollers and placing a low set stack of bricks in need of firing on the conveyor of the first carriage. The embodiment sets forth positioning the first and second carriages to a position where the spaced-apart rollers of the second carriage rise between the cross-beams and extend vertically above a selected one of the multiple support levels. Further, this embodiment involves driving the conveyor of the first carriage and the rollers of the second carriage to convey a low set stack of bricks from the first carriage to the second carriage; and lowering the second carriage until the low set stack of bricks rests directly on the cross-beams of the first level of the kiln car. The second carriage is then withdrawn horizontally until it is free of the furniture. In a further refinement of this embodiment, the step of positioning the first and second carriages to a position where the spaced-apart rollers of the second carriage rise between the cross-beams involves vertically moving the first carriage to a position wherein the conveyor is at a vertical height slightly lower than a selected one of the multiple support levels, horizontally extending the second carriage under the selected level to a position wherein the second carriage is adjacent to the first carriage, and elevating the first and second carriages so that the spaced-apart rollers of the second carriage rise between the cross-beams and extend vertically above the selected level.

A method for unloading is also provided generally in which the loading steps are performed in reverse. In a further refinement of the method for unloading, the cross-beams are rotated after unloading the bricks.

In one embodiment, according to an aspect of the invention, the vertical posts of the furniture are securely fixed relative to the chassis of the kiln car. The vertical posts may be securely fixed using refractory concrete. An advantage is that automated loading and unloading of bricks from the furniture can be performed more reliably and precisely. More particularly, the securely fixed posts maintain the furniture in a predetermined position relative to the chassis so that the loading/unloading machine can be reliably positioned relative to the furniture and brick stacks thereon.

In a further embodiment, a system for loading a kiln car is provided. The system includes, for example, a kiln car having furniture with multiple levels and proximal distal ends, wherein the furniture is constructed using silicon carbide support posts for vertical support, and where each of the multiple levels include silicon carbide main support beams with cross-beams for receiving the bricks disposed between the main support beams; a first machine comprising a first carriage containing a conveyor and a means for powering the the conveyor; and a second machine comprising a second carriage containing rollers and a means for powering the rollers wherein the rollers are configured to extend above the multiple horizontal beams when the second carriage is extended beneath the base of the kiln car and raised until the rollers are positioned above the horizontal beams, and wherein the distal end of the kiln car is adjacent to the first carriage and the proximal end of the kiln car is adjacent to the second carriage.

The kiln car of the present invention has been found to be highly durable and permits a high-capacity configuration of bricks that can be efficiently fired without premature wear to the kiln car. The configuration of bricks also provides for the most efficient firing while minimizing the amount of defective product. Because the bricks are only stacked to a maximum level of two bricks, less breakage and less defective product occurs. Moreover, the useful life of the kiln car of the present invention is estimated to be much longer than conventional kiln cars. In addition to lower capital cost, the present invention may lead to lower fuel consumption while producing higher quality bricks.

Additional features and advantages of the present invention will be apparent from the description, claims, and drawings herein.

### BRIEF DESCRIPTION OF THE DRAWINGS

FIG. 1 is a system layout for processing bricks according to an embodiment of the invention.

FIG. 2A-2D illustrates the loading of a kiln car with bricks using a first carriage containing a conveyor and a second carriage containing rollers according to an embodiment of the invention.

FIG. 3A-3C illustrates the loading of a kiln car with bricks using a gantry with a fork according to an embodiment of the invention.

FIG. 4 is a schematic side elevation of a kiln car showing bricks loaded in a spaced manner according to a system and method having features in accordance with teachings of the present invention.

FIG. 5 is a schematic top view of the kiln car of FIG. 4.

FIG. 6 is a front elevation of the kiln car of FIG. 4 including exemplary furniture constructed of refractory material for supporting bricks during firing, which can be used in accordance with the system and method of the present invention.

### DETAILED DESCRIPTION OF THE INVENTION

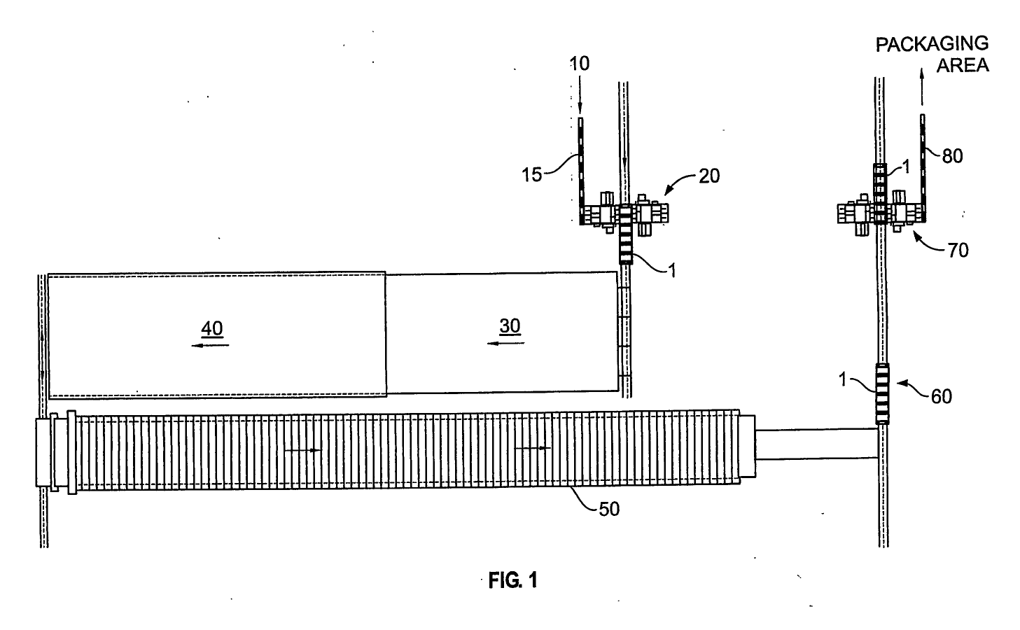

Now referring to the drawings, wherein like numerals designate like components, FIG. 1 illustrates a system for processing bricks according to the present invention. According to an embodiment shown in FIG. 1, green bricks are formed, such as by extrusion, and loaded onto a first conveyor 15 in an extrusion area 10. The bricks are then moved, by powering the conveyor, to a loading area 20 where the bricks are loaded onto a kiln car 1. The kiln car 1 moves throughout the entire system by way of rail. After the kiln car is fully loaded with bricks, the kiln car travels to a brick holding area 30 where the kiln car is held until the dryer 40 has available space for the kiln car. When space becomes available in the dryer 40, the kiln car is moved into the dryer 40 which heats the bricks at a sufficient temperature for a sufficient time to lower the moisture content of the bricks so that they do not explode upon entering the kiln 50. After the bricks have been sufficiently dried, the kiln car enters the kiln 50 which fires the bricks at a sufficient temperature for a sufficient time to produce bricks that meet generally known specifications in the brick industry. After the bricks have been sufficiently fired, the kiln car moves to a brick storage area 60 and then to an unloading area 70. The bricks are unloaded from the kiln car 1 onto a conveyor 80. The bricks are then moved, by powering the conveyor, to a packaging area.

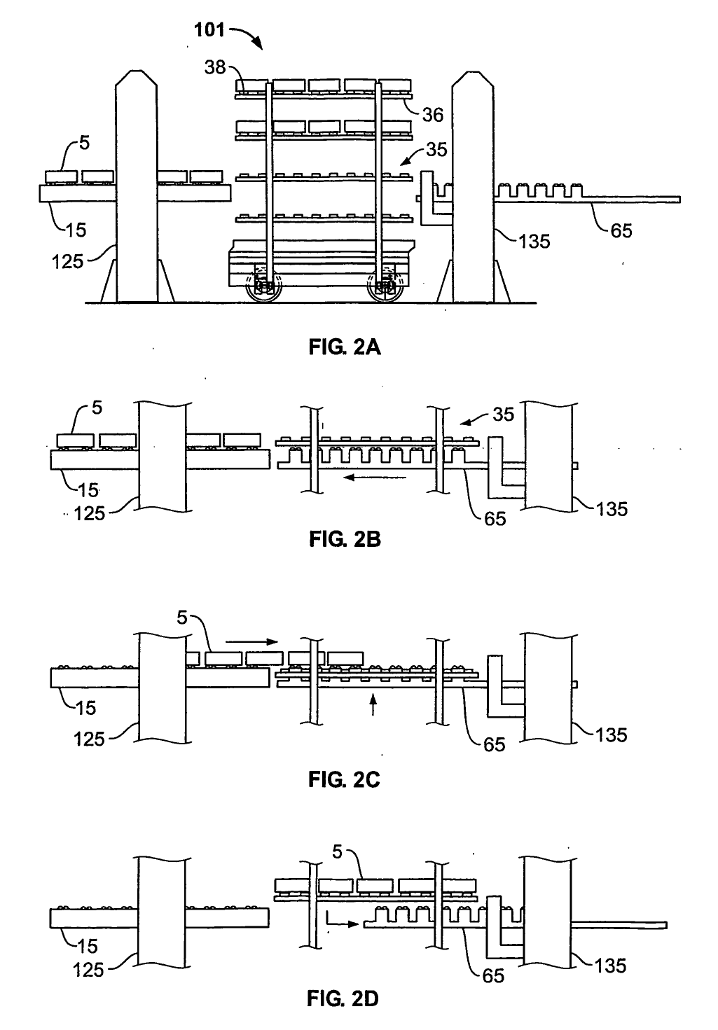

FIGS. 2A-2D shows the sequential steps for loading the bricks on a kiln car 101 in the loading area 20 depicted in FIG. 1 according to one embodiment of the invention. In FIG. 2A, the first carriage containing a conveyor 15 is shown loaded with bricks 5 and positioned slightly below the horizontal support beams of an unoccupied level 35 of the kiln car 101. Each level of the kiln car includes horizontal support beams 36 and cross-beams 38, where cross-beams 38 will support the bricks 5 and horizontal support beams 36 support cross-beams 38. The horizontal support beams 36 rest on lugs 105 affixed to vertical supports 200. Lugs 105 may include a raised portion to help maintain the position of the horizontal support beams 36 as they rest on the lugs.

A first machine 125 provides power to the first carriage containing a conveyor 15. A second carriage containing rollers 65 is positioned on the opposite side of the kiln car 101. A second machine 135 provides power to the second carriage containing rollers 65. FIG. 2B shows the second carriage containing rollers extending into the kiln car so that the first carriage containing a conveyor 15 and the second carriage containing rollers 65 are adjacent to one another. In one embodiment of the present invention, carriage 65 is sufficient to support the entire weight of the loaded bricks 5. In another embodiment, carriages 15 and 65 may be interconnected to provide additional support from carriage 15 for carriage 65 during loading. FIG. 2C shows the first carriage containing a conveyor 15 and the second carriage containing rollers 65 raised to a level slightly above the horizontal support beams of an unoccupied level of the kiln car 35. Spaces are provided between the rollers to allow the first and second carriages to pass through the cross-beams of the unoccupied level of the kiln car 35. FIG. 2C further shows the bricks 5 being moved from the first carriage containing a conveyor 15 to the second carriage containing rollers 65. After all of the bricks 5 have been transferred to the second carriage containing rollers 65, the first carriage containing a conveyor 15 and the second carriage containing rollers 65 are lowered, leaving the bricks resting on the cross-beams of the kiln car, as depicted in FIG. 2D. The second carriage is then withdrawn from the kiln car.

In one refinement of this embodiment of the present invention, cross-beams 38 of each level 35 of kiln car 101 are rotated between loading and firing cycles in order to extend the operational life of the cross-beams. This permits the cross-beams to be constructed using materials other than silicon carbide that are generally less expensive, but less durable, such as cordierite or mullite. Between firing cycles, the cross-beams may begin to sag due to the high heat. By rotating the cross-beams between cycles, the sagging that occurs during one cycle is counteracted by the sagging that occurs during a subsequent cycle such that the cross-beams remain substantially horizontal.

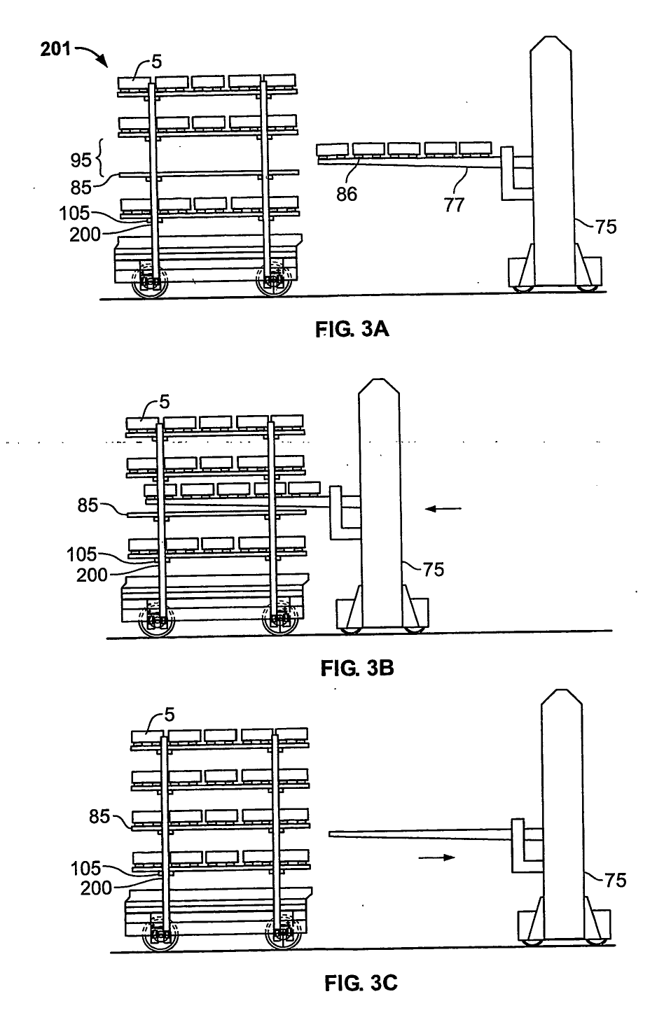

FIGS. 3A-3C illustrates the sequential steps for loading a kiln car 201 in the loading area 20 of FIG. 1 according to a further embodiment of the present invention. After the bricks travel from the extrusion area 10 of FIG. 1, they are loaded onto cross beams 86 that have been sized and configured to rest on the horizontal support beams 85 of a kiln car 201. The cross beams 86 loaded with bricks 5 are moved by means of a gantry 75 containing a fork 77 into one of the unoccupied bays 95 of a kiln car 201. In this embodiment, horizontal support beams 85 support cross beams 86 and the horizontal support beams 85 rest on lugs 105 affixed to vertical supports 200. As discussed above, cross-beams 86 may be rotated between firing cycles.

In one embodiment, the cross beams that support the bricks during drying and firing are rectangular in cross-section and rest in corresponding depressions in the horizontal support beams. However, cross beams having other cross-sectional configurations may be used. In another embodiment, the cross beams have a circular cross-section to permit the cross beams to rotate during drying and firing of the bricks in order to reduce stress on the brick. In this embodiment, the corresponding depressions in the horizontal support beams are tapered in the direction of shrinkage of the brick so that the circular cross beams roll back to their original position after the bricks are removed. A carriage with powered rollers may be used to load and unload the cross beams, in which case the carriage may include horizontal beams having depressions for receiving the cross beams that are similar to the depressions in the horizontal support beams of the kiln car.

In FIG. 3A, the fork of the gantry 75 picks up the cross beams 86 loaded with bricks 5. In FIG. 3B, the gantry 75 moves the cross beams 86 containing bricks 5 into an unoccupied bay 95 of kiln car 201. FIG. 3C shows the cross beams containing bricks 5 loaded into a bay of the kiln car and the fork of the gantry 75 removed from the bay 95 of the kiln car 201. Note that bricks may be loaded onto or unloaded from the cross beams 86 using a carriage or conveyer with powered rollers similar to carriage 65 shown in FIGS. 2A-D.

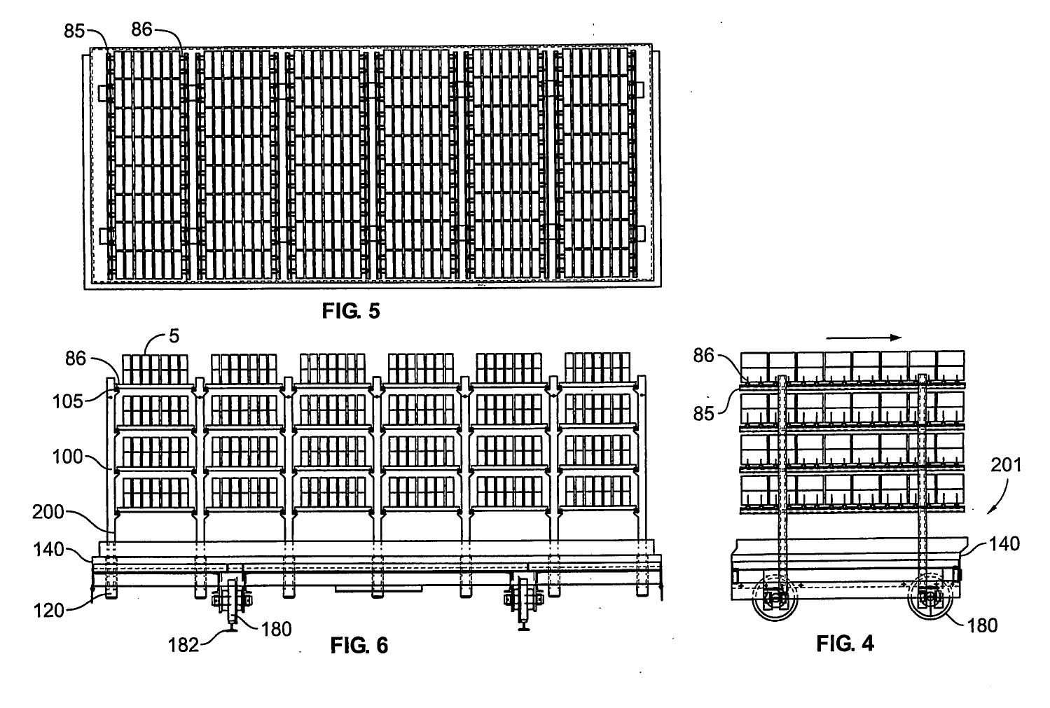

FIGS. 4-6 illustrate a kiln car 1 loaded bricks 5 according to a configuration of the invention. The kiln car 1 is generally used for supporting bricks during drying within a dryer 40 and firing within a kiln 50 as shown in FIG. 1. The kiln car 1 includes a chassis 140 having wheels 180 that ride on rails 182 to guide the kiln car through the dryer 40 and kiln 50. To support bricks to be fired, the kiln car 1 further includes kiln car furniture 100 supported on the chassis 140. The furniture 100 is constructed of a high-temperature resistant refractory material, such as silicon carbide. The furniture 100 includes vertical support members 200, horizontal support beams 85 and crossbeams 86. The vertical support members are anchored into steel sockets 120 in the kiln car chassis 140 using refractory concrete, which secures the vertical support members 200 to the chassis 140. By securely fixing the vertical support members in place, the position of the vertical support members remains precise such that the automated loading and unloading of bricks from the furniture 100 can be performed more reliably. FIG. 4 shows a side view of a loaded kiln car with the arrow showing the direction that the kiln car moves through the kiln 50. FIG. 5 is a top view of the kiln car of FIG. 4. FIG. 6 is a front view of the kiln car of FIG. 4. In FIG. 6, the horizontal support beam 85 is shown resting on lugs 105 that are positioned along the vertical support members or posts 200. Alternatively, the vertical support members may be formed with openings for support of the horizontal support beams. In another alternative, pins may be provided for affixing the horizontal support beams to the vertical support members.

According to an aspect of the present invention, a system and method of loading green, unfired bricks on a kiln car in a particular configuration are provided so as to maximize the efficiency of their processing. As shown in FIGS. 4-6, for example, the configuration of bricks when the bricks are loaded on the levels of the kiln car allows for the most efficient processing of the bricks through the dryer and kiln. The bricks are stacked in a plurality of “low stack” sets, each set being, for example, two bricks high, 8 bricks long and 6 bricks wide. Six sets of bricks occupy each level, but the number of sets per level can vary based on the dimensions of the kiln. Each set of bricks is located between the silicon carbide vertical support beams. Air space of approximately four inches occupies the area along the sides and tops of the groups. This configuration allows for the bricks to be heated individually, resulting in uniform temperatures of the bricks. As with firing, the drying process can be accelerated with the present invention because the heated air passes around the individual bricks. Faster cycles result in smaller kilns and dryers that have a significant impact on the capital expenditures of new plants.

To further improve the efficiency of brick firing, the kiln car is configured to allow for hotter temperatures and faster heating of the bricks by the dryer and the kiln. The kiln car furniture 100 has multiple levels for holding the bricks. As illustrated in FIG. 6, the furniture 100 includes silicon carbide support posts 200 for vertical support which are anchored into steel sockets 120 in the kiln car frame 140 using refractory concrete. In an embodiment of the invention, lugs 105 are positioned along the vertical support posts 200 for supporting the horizontal support beams 85, which, in turn, support cross-beams 86. As noted above, other ways of vertically supporting the support beams 85 may be used, such as openings in the support posts 200 or pins.

In another embodiment, each of the multiple levels of the kiln car furniture has silicon carbide horizontal support beams which are attached to the silicon carbide vertical support posts. Cross-beams, running between the horizontal support beams, rest on the horizontal support beams, where the cross-beams may be made of cordierite, mullite or silicon carbide. As noted above, the cross-beams may be rotated between firing cycles in order to extend the life of the cross-beams. The cross beams are adapted to receive a stack of bricks from a carriage containing rollers. The kiln car facilitates the stacking of bricks on multiple levels, preferably four levels, but the number of levels can vary depending on the dimensions of the kiln.

The levels of the kiln car furniture are spaced such that the hot gases from the kiln can circulate heat among the respective levels independently. The bricks are placed on the cross beams so that they are heated individually, not in packs, by having the kiln gases pass around the individual bricks. The bricks may be stacked in a “low stack” up to two bricks high. This configuration provides a lower thermal capacitance per stack and accordingly allows for a faster rate of heating, thereby leading to faster firing cycles.

The kiln car frame is insulated with ceramic fiber in the area around the posts. The ceramic fiber has a much lower density than conventional refractory that carries the load of bricks in addition to insulating the frame of conventional kiln cars. Because the density of the ceramic fiber is much lower than the density of conventional refractory, less heat is required to heat the low mass ceramic fiber, thus saving fuel with the use of ceramic fiber.

An embodiment of loading the kiln car is directed to a first machine having a first carriage with a conveyor and a second machine having a second carriage with rollers. A 2-high by 6 wide by 8 long stack of 8 inch brick is placed on the conveyor of the first carriage. To load and unload the kiln car of the present invention, a kiln car having multiple levels and proximal distal ends is positioned in between the first machine and the second machine so that the proximal end of the kiln car is adjacent to the first machine and the distal end of the kiln car is adjacent to the second machine. After the kiln car is positioned between the two machines, the first carriage is positioned to a level where the conveyor is slightly below a first one of the multiple levels of the kiln car. The second carriage is then positioned so that the second carriage is adjacent to the first carriage. The first and second carriages are then raised to a position where the rollers of the second carriage extend above the cross-beams of the first level. The first machine powers the conveyor and the second machine powers the rollers to move the entire level of bricks from the first carriage to the second carriage. After the stack of bricks is completely resting on the rollers of the second carriage, the second carriage is lowered until the stack of bricks is resting on the cross-beams of the first level. The second carriage is then withdrawn from the kiln car and the first carriage is moved back to its original position. Preferably, loading starts at the top level and repeats until all levels are loaded.

For unloading, the loading process is generally performed in reverse. After the kiln car loaded with fired bricks is positioned between the two machines, the first carriage is positioned to a level where the conveyor is slightly below a first one of the multiple levels of the kiln car. The second carriage is then positioned so that the second carriage is adjacent to the first carriage. The first and second carriages are then raised to a position where the rollers of the second carriage extend above the cross-beams of the first level. The conveyor of the first carriage and the rollers of the second carriage are powered to move the entire level of bricks from the second carriage to the first carriage. After the stack of bricks is completely resting on the conveyor of the first carriage, the second carriage is then withdrawn from the kiln car. Preferably, unloading begins at the bottom level and moves upward until all four levels are unloaded.

Another embodiment for loading and unloading a kiln car employs a loading machine having a gantry, containing preferably a 2-axis Servo Control Unit, and an arm with a fork for loading and unloading a entire level of bricks (2-high by 8 wide by 7 long of 8 inch brick) on a kiln car. The entire level of bricks is placed on more than one cross beam which are lifted by the fork of the loading machine and placed on the horizontal support beams of the kiln car. The upper most level of the kiln car is loaded first and proceeds downward until all the levels of the kiln car are filled with bricks. When the kiln car is unloaded, the fork of the loading machine simply lifts the cross beams containing the bricks from the horizontal support beams of the kiln car. Unloading begins from the bottom level and proceeds upward until all levels of the kiln car are empty.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

1. A method for loading bricks comprising the steps of:
providing a kiln car having furniture defining multiple support levels, the furniture including vertical posts made of silicon carbide, and wherein each of the support levels includes a plurality of horizontal support beams made of silicon carbide, each of the horizontal support beams being mounted to extend between a pair of the posts, and a plurality of generally parallel, horizontal cross-beams extending between the support beams, the kiln car having opposite proximal and distal ends;
positioning the kiln car between a first machine and a second machine, the first machine including a first carriage with a conveyor, the second machine including a second carriage with rollers, the proximal end facing the first carriage, and the distal end facing the second carriage, the second carriage having a plurality of spaced-apart rollers;
placing a low set stack of bricks in need of firing on the conveyor of the first carriage;
positioning the first and second carriages to a position where the spaced-apart rollers of the second carriage rise between the cross-beams and extend vertically above a selected one of the multiple support levels;
driving the conveyor of the first carriage and the rollers of the second carriage to convey a low set stack of bricks from the first carriage to the second carriage; and
lowering the second carriage until the low set stack of bricks rests directly on the cross-beams of the first level of the kiln car.

2. The method of claim 1, where the step of positioning the first and second carriages to a position where the spaced-apart rollers of the second carriage rise between the cross-beams and extend vertically above a selected one of the multiple support levels further comprises the steps of:
vertically moving the first carriage to a position wherein the conveyor is at a vertical height slightly lower than a selected one of the multiple support levels;
horizontally extending the second carriage under the selected level to a position wherein the second carriage is adjacent to the first carriage; and
elevating the first and second carriages so that the spaced-apart rollers of the second carriage rise between the cross-beams and extend vertically above the selected level.

3. The method of claim 1, further comprising the step of horizontally withdrawing the second carriage.

4. The method of claim 1 wherein the furniture defines four support levels.

5. The method of claim 1 wherein the selected level in the step of vertically moving first includes moving the kiln car is the upper most level of the kiln car.

6. The method of claim 1 wherein the horizontal support beams are mounted to the vertical posts using at least one of a lug, an opening formed in the vertical post, and a pin.

7. The method of claim 1 further comprising
placing at least one work piece in need of firing on the first carriage;
vertically moving the first carriage to a position wherein the conveyor is at a height slightly below a different selected level of the kiln car;
horizontally extending the second carriage under said different selected level to a position wherein the second carriage is adjacent to the first carriage;
elevating the first and second carriages to a position where the rollers of the second carriage extend above the horizontal beams of said different selected level;
driving the conveyor of the first carriage and the rollers of the second carriage to move the work piece from the first carriage to the second carriage;
lowering the second carriage until the work piece rests on the base of the second level of the kiln car; and
withdrawing the second carriage from the kiln car.

8. The method of claim 7 wherein the second level of the kiln car is below the first one of the multiple levels of the kiln car.

9. A method of unloading a kiln car comprising:
providing a kiln car having furniture defining multiple support levels supporting a low set stack of bricks, the furniture including vertical posts made of silicon carbide, and wherein each of the support levels includes a plurality of horizontal support beams made of silicon carbide, each of the horizontal support beams being mounted to extend between a pair of the posts, and a plurality of generally parallel, horizontal cross-beams extending between the support beams to support the bricks, the kiln car having opposite proximal and distal ends;
positioning the kiln car between a first machine and a second machine, the first machine including a first carriage with a conveyor, the second machine including a second carriage with rollers, the proximal end facing the first carriage, and the distal end facing the second carriage, the second carriage having a plurality of spaced-apart rollers;
vertically moving the first carriage to a position wherein the conveyor is slightly below a selected one of the levels supporting the low set stack of bricks;
horizontally extending the second carriage under said selected level to a position wherein the second carriage is adjacent to the first carriage;
elevating the first and second carriages so that the spaced-apart rollers of the second carriage rise between the cross-beams and extend vertically above the selected level, thereby lifting the low set stack of bricks to rest on the rollers of the second carriage;
driving the conveyor of the first carriage and the rollers of the second carriage to move the low set stack of bricks from the second carriage to the rollers of the first carriage;
lowering the second carriage free of the cross beams; and
withdrawing the second carriage from the kiln car.

10. The method of claim 9, wherein the first one of the multiple levels of the kiln car containing the low set stack of bricks is the lowest most level of the kiln car.

11. The method of claim 9, wherein the furniture has four levels.

12. The method of claim 9, the method including the step of rotating the cross beams.

13. The method of claim 9 wherein the horizontal support beams are mounted to the vertical posts using at least one of a lug, an opening formed in the vertical post, and a pin.

14. A system for loading a kiln car comprising:
a kiln car including a chassis, wheels mounted to the chassis to rollably support the chassis, and furniture supported on the chassis, furniture defining multiple support levels, the furniture including vertical posts made of silicon carbide, each of the posts being securely fixed relative to the chassis, and wherein each of the support levels includes a plurality of horizontal support beams made of silicon carbide, each of the horizontal support beams being mounted to extend between a pair of the posts, and a plurality of generally parallel, horizontal cross-beams extending between the support beams, the kiln car having opposite proximal and distal ends, each of the levels being configured to support at least one low set stack of bricks;
a first machine comprising a first carriage containing a conveyor and a means for driving the conveyor to convey a stack of bricks; and
a second machine comprising a second carriage containing rollers to convey a stack of bricks and a means for driving the rollers, wherein the at least some of the rollers are spaced apart to fit between the horizontal beams of a selected one of the levels, permitting the rollers to extend vertically above the horizontal beams;
wherein the second carriage is positionable close to the first machine to convey a stack of bricks between the carriages.

15. The system of claim 14, wherein the furniture has four levels.

16. The method of claim 14 wherein the horizontal support beams are mounted to the vertical posts using at least one of a lug, an opening formed in the vertical post, and a pin.

17. A method for loading bricks comprising the steps of:
providing a kiln car having furniture, the furniture including vertical posts and horizontal support beams made of silicon carbide, the horizontal support beams being mounted at vertical increments defining multiple levels, the furniture further including a plurality of cross beams, each of the cross beams configured to fit between pairs of the horizontal support beams, the cross beams configured for holding a low set stack of bricks and adapted to accepting a fork that can support the cross beams and bricks thereon;
moving the fork to supportably engage the cross beams in a brick loading area, the cross beams supporting a low set stack of bricks;
maneuvering the fork and cross beams between horizontal support beams generally to a selected one of the multiple levels;
placing the cross beams on the horizontal support beams; and
withdrawing the fork from the tray.

18. The method of claim 17, wherein the horizontal support beams are mounted to the vertical posts using at least one of a lug, an opening formed in the vertical post, and a pin.

19. A method for firing bricks comprising the steps of:
providing a kiln car having furniture, the furniture including vertical posts and horizontal support beams made of silicon carbide, the horizontal support beams being mounted at vertical increments defining multiple levels, the furniture further including a plurality of cross beams, each of the cross beams configured to fit between pairs of the horizontal support beams, each of the plurality of cross beams spaced apart from one another and configured for holding at least one low set stack of bricks;
disposing at least one low set stack of bricks on the cross beams of each level of the kiln car, wherein each low set stack of bricks is located between the vertical support beams and air space occupies the area along the sides and top of each low set stack of bricks; and
passing the kiln car through a tunnel kiln.

20. The method of claim 19, wherein the kiln car includes four levels.

21. The method of claim 19, wherein the horizontal support beams are mounted to the vertical posts using at least one of a lug, an opening formed in the vertical post, and a pin.
